(19) United States
(12) Patent Application Publication
(10) Pub. No.: US 2026/0121738 A1
(43) Pub. Date: Apr. 30, 2026

(54) Method and Apparatus for Polarization-Transparent Channel Switching in Satellite-RAN Communication

(71) Applicant: AST & Science, LLC, Miami, FL (US)

(72) Inventors: Federico Pedro Fawzi, Midland, TX (US); Mariano Boragno, Odessa, TX (US); Vani Murthy Vellanki, Midland, TX (US); Ruby Escobedo, Midland, TX (US); Abel Avellan, Coral Gables, FL (US); Piotr Gawlowicz, Berlin (DE); Justin C. Tallon, Barcelona (ES)

(73) Assignee: AST & Science, LLC, Miami, FL (US)

(21) Appl. No.: 19/180,231

(22) Filed: Apr. 16, 2025

Related U.S. Application Data
(60) Provisional application No. 63/663,904, filed on Jun. 25, 2024.

(51) Int. Cl. H04B 7/185; H04B 7/195

(52) U.S. Cl. CPC H04B 7/18543; H04B 7/18558; H04B 7/195

(57) ABSTRACT

The technology employs a polarization switching technique in a satellite-based cellular communication system, in order to prevent dropped connections when communicating with client communication devices. The polarization switching is implementable without requiring additional antenna elements on the satellite(s), while enabling the satellites(s) to be agnostic to the polarization transmitted by user equipment. The dwell time is selected so that the polarization switching is transparent to the users of the client computing devices. In one configuration, certain antenna elements can be set to handle a vertically polarized downlink and a horizontally polarized uplink, while other elements are set to handle a vertically polarized uplink and a horizontally polarized downlink, although other polarization configurations may be employed. A digital switch with a general purpose I/O (GPIO) controller may be employed for switching according to the dwell time.

### CROSS-REFERENCE TO RELATED APPLICATIONS

This application claims the benefit of the filing date, and priority to, U.S. Provisional Patent Application No. 63/663,904, filed Jun. 25, 2024, the entire disclosure of which is incorporated by reference herein.

### BACKGROUND

Wireless cellular communications systems, such as those where mobile phones and other portable client communication devices are employed, use one or more antennas of the devices to transmit and receive information. Typically, the client communication devices transmit signals having a specific polarization, such as horizontal polarization, vertical polarization, or even 45° polarization. If the receiving device, such as a base station, eNodeB, or satellite, is operating in the opposite polarization (e.g., vertical instead of horizontal, or vice versa) then the signal from the client device may not be received at all due to the polarization mismatch. Even with 45° polarization on the transmit side, if the receiving device is configured for a different polarization, the signal may be received below a desired power level (e.g., the effective isotropic radiated power (EIRP) may be below a required threshold) or below a minimum acceptable bit rate (e.g., the bit error rate (BER)). Either situation can degrade or completely prevent suitable communication between the devices. In a terrestrial system, the receiving device such as the base station or eNodeB may duplicate equipment to support the different polarization options. However, in a satellite-based cellular communication system, this may not be feasible, e.g., due to restrictions on component or satellite size, or due to a reduction in efficiency of the feeder link.

### BRIEF SUMMARY

Aspects of the technology employ a polarization switching technique in a satellite-based cellular communication system, in order to prevent dropped connections when communicating with client communication devices. Such devices, also referred to as user equipment (UE), may be, e.g., mobile phones, tablet or laptop computers, etc., which can be stationary or mobile, either on the ground, in the air or at sea. The polarization switching technique can be implemented without requiring additional antenna elements on the satellite(s), while enabling the satellites(s) to be agnostic to the polarization transmitted by the UEs. The dwell time is selected so that the polarization switching is transparent to the users of the client computing devices. In one configuration, certain antenna elements can be set to handle a vertically polarized downlink and a horizontally polarized uplink, while other elements are set to handle a vertically polarized uplink and a horizontally polarized downlink, although other polarization configurations may be employed. By way of example, a digital switch with a general purpose I/O (GPIO) controller may be employed, in which the switch is configured switch between two different positions, one for horizontal polarization and another for vertical polarization at a selected dwell time. This approach can result in improved communication connection quality and a reduction in dropped calls.

According to one aspect of the technology, a satellite communication system comprises a plurality of antenna elements spatially arranged together to form an antenna array for operation in Low Earth Orbit (LEO), and a switching module operatively coupled to each of the plurality of antenna elements in the antenna array. The plurality of antenna elements is configured to support a plurality of uplink beams and a plurality of downlink beams to communicate with one or more user equipment (UE) within a geographic area on Earth. The switching module is configured to switch selected ones of the plurality of antenna elements in the antenna array between a first polarization and a second polarization at a selected dwell time that maintains communication with the one or more UE with a threshold feeder link efficiency. The system is configured to align a polarization change to switch the selected antenna elements between the first and second polarizations to enable communication between the one or more UE and a ground station.

The following alternatives and variations are not mutually exclusive. In one example, the switching module comprises a double pole-double throw configuration to simultaneously support communication via the plurality of uplink beams and the plurality of downlink beams. In one scenario, a communication link between the one or more UE and the ground station has a dual polarization bent pipe configuration. The antenna array may be configured to transmit two and receive two collocated beams for each cell within a field of view of the antenna array. The switching module may be configured to switch all of the plurality of antenna elements at the selected dwell time to either the first polarization or the second polarization. When one of the first polarization and the second polarization is horizontal polarization, the other one of the first polarization and the second polarization is vertical polarization.

According to another aspect of the technology, a method comprises: supporting, by a plurality of antenna elements spatially arranged together to form an antenna array of a satellite communication system in Low Earth Orbit (LEO), a plurality of uplink beams and a plurality of downlink beams to communicate with one or more user equipment (UE) within a geographic area on Earth; and switching, by a switching module of the satellite communication system, selected ones of the plurality of antenna elements in the antenna array between a first polarization and a second polarization at a selected dwell time to maintain communication with the one or more UE with a threshold feeder link efficiency; wherein aligning a polarization change to switch the selected antenna elements between the first and second polarizations enables communication between the one or more UE and a ground station.

The following alternatives and variations are not mutually exclusive. A communication link between the one or more UE and the ground station may have a dual polarization bent pipe configuration. The method may further comprise the antenna array transmitting two and receiving two collocated beams for each cell within a field of view of the antenna array. The switching may include switching all of the plurality of antenna elements at the selected dwell time to either the first polarization or the second polarization.

### BRIEF DESCRIPTION OF THE DRAWINGS

FIGS. 1(a)-(b) illustrate example communication systems for use with aspects of the technology.

FIG. 2 illustrates an example of polarized signal transmission in accordance with aspects of the technology.

FIG. 3 illustrates an example communication scenario in accordance with aspects of the technology.

FIG. 4 illustrates an exemplary ground station that may be employed with aspects of the technology.

FIG. 5 is an example of polarization beamforming in accordance with aspects of the technology.

FIG. 6 illustrates another example of polarization beamforming in accordance with aspects of the technology.

FIG. 7 illustrates an example of channel quality indicator encoding in accordance with aspects of the technology.

FIG. 8 illustrates a dual rate control element approach in accordance with aspects of the technology.

FIG. 9 illustrates an example method in accordance with aspects of the technology.

### DETAILED DESCRIPTION

### Example Satellite Communication Systems

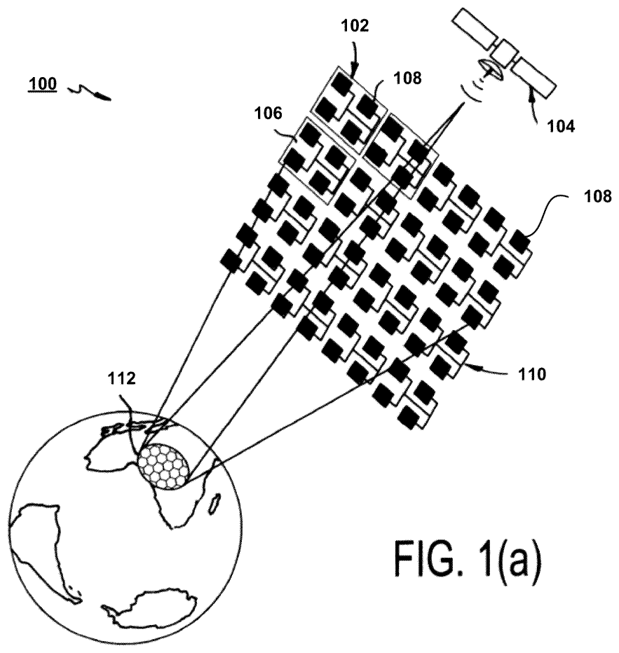

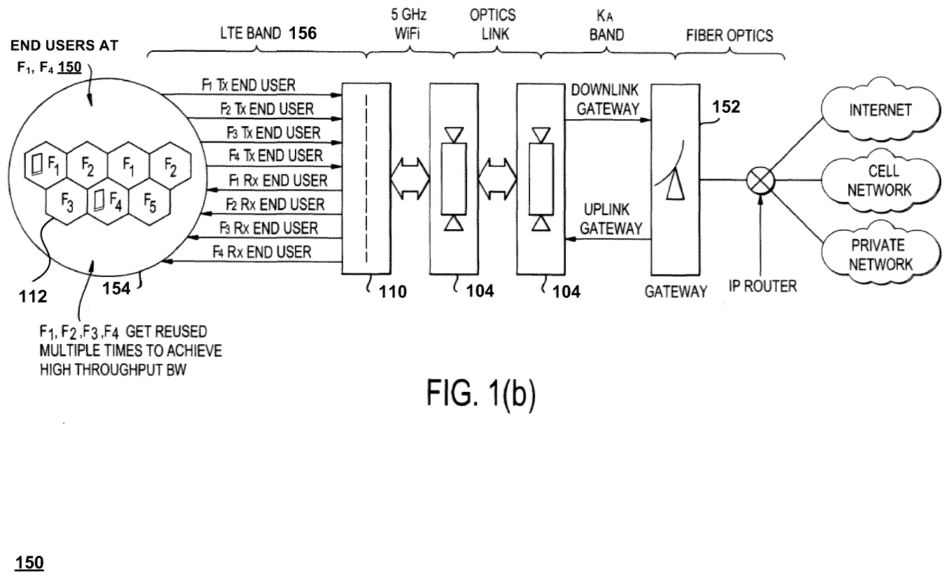

FIG. 1(a) illustrates a satellite system 100 as an exemplary, illustrative, non-limiting approach, which can be employed with aspects of the technology. The satellite system 100 may, as shown, include a plurality of elements such as satellites 102, which may operatively couple to a control satellite 104. The satellites 102 can be any suitable satellite such as for example, altitude-controlled satellites that are very small in size and can be lightweight (e.g., <1.5 Kg in weight). A set of antenna elements may be integrated into a single assembly. For example, as shown, each satellite 102 can include a housing 106 that houses, e.g., a plurality of antennas 108 that can be operatively connected together. Alternatively, each satellite 102 may have one antenna 108.

The satellites 102 may each include a local controller (e.g., processor or processing device) with a control interface, one or more antennas, and a transmitter and/or receiver (or transceiver). The transmitter/receiver (or transceiver) are configured to communicate with the control satellite 104 such as via wireless communication network. The satellites 102 may be solar-cell powered and have a chargeable capacitor or battery for eclipses or the like.

The satellites 102 and/or the control satellite 104 may be operated in low Earth orbit (LEO). For instance, the satellites 102 and 104 may operate below the Van Allen belt of plasma at 700 km/1400 km because operating above the Van Allen Belt requires more expensive space-hardened components. However, the technology is not limited to any particular orbit or combination of orbits, and other suitable orbits can be utilized on all LEO, medium Earth orbit (MEO) and geosynchronous Earth orbits (GEO), including above the Van Allen Belt.

The satellite system 100 (including the control satellite 104 and the satellites 102), may have two primary configurations: an operating or deployed configuration, and a shipping or storage configuration. In the operating configuration, a plurality of the satellites 102 may be arranged together in space to form an array 110. In one example, tens, hundreds, or thousands of satellites 102 are provided, though there may be any number of satellites 102 in the array 110. The array 110 may be configured to form a very large spatial array. In an example embodiment of 1,000 satellites 102, the array 110 can be over 500 meters in width and/or height. In the array configuration, the antennas 108 of the distributed satellites 102 may be functionally equivalent to a large unitary antenna that enhances communication with the Earth. The satellites 102, in essence, are fractionated in that they provide a distributed phased-array antenna, rather than a monolithic array. This distributed phased-array is configured to provide cellular communication to a set of cells 112 as shown in FIG. 1(a). Also in the operating configuration, the array 110 may be formed about the control satellite 104. The array 110 is positioned and configured to face the Earth as shown in FIG. 1(a). Moreover, in one scenario, the control satellite 104 is one of the satellites 102, while in another scenario, the control satellite 104 is distinct from the satellites that form the array 110.

While only one array 110 is shown in FIG. 1(a), there may be multiple arrays 110 formed with different sets of satellites 102. A separate control satellite 104 may be provided for each array 110. In one embodiment, the control satellite 104 can be a CubeSat or a small satellite. The control satellite 104 is configured to communicate with each of the satellites 102 in its respective array 110. For example, each control satellite 104 can have a central controller (e.g., processor or processing device) that communicates with the local controller of each of the satellites 102. The central controller can control operation of the satellites 102 in that array 110 via the controllers at each satellite 102, such as during normal communications between the control satellite 104, the satellites 102, one or more ground stations of a cellular communication network, and/or one or more client communication devices (e.g., mobile phones), and can implement commands to the satellites 104 that are received from the ground station(s). The central controller can control operation of the distributed phased-array, such as to provide communication beams to various user devices (e.g., mobile phones) and/or network devices (e.g., an eNodeB) in different cells 112.

Referring to FIG. 1(b), an exemplary communication scheme 150 is shown. In this example, end user terminals 150 are configured to directly communicate with the satellites 102 of a given array 110 via, e.g., a sub 2 GHz frequency. This frequency, which may be an operating frequency pursuant to a terrestrial cellular communication standard (e.g., GSM, CDMA, LTE or another 5G or later standard) is called the Tx end user frequency. As shown in this example, the ground footprint cells 112 each communicate on one of four different frequencies. That is, an end user terminal 150 in a first footprint cell communicates at a first frequency F₁, the end user terminal 500 in a second footprint cell communicates at a second frequency F₂, the end user terminal 500 in a third footprint cell communicates at a third frequency F₃, and the end user terminal 500 in a fourth footprint cell communicates at a fourth frequency F₄. Thus, the frequencies F₁-F₄ can be reused multiple times in order to communicate with end user terminals located in multiple different footprint cells, which enables a high throughput bandwidth. Multiple end user terminals 150 that are located in the same cell (e.g., the first footprint cell), can communicate over the same frequency (here, the first frequency F₁) by use of time division multiplexing or other suitable transmission schemes.

The multitude of satellites 102 and the control satellite 104 may be configured to form a wireless network to communicate between them in order to aggregate the satellite 102 receive signals from the array 110 at the control satellite 104 and to aid the positioning satellite system. As shown, there can be multiple control satellites 104 that communicate with each other or with a given array 110.

Each control satellite 104 may be configured to communicate with a gateway 152 (which for example can be located at a ground station on Earth, such as a base station or eNodeB) via a high frequency link, such as a KA band or V band link. The gateway 152 is, in turn, configured to communicate with the Internet, terrestrial cellular systems and/or private network (such as via a fiber optic link or other link). The frequency between the control satellite 104 and the gateway 152 is referred to as the downlink gateway frequency. The gateway 152 communicates back to the control satellite 104, also via a high frequency. This frequency is referred to as the uplink gateway frequency.

Thus, the control satellite 104 can distribute signals to different satellites 102 in such a way that transmit signals to selected cells on the Earth generate specific beam forming 154 on the Earth field of view. The multitude of satellites 102 transmit back to the end user devices 150. This frequency is called the Rx end user frequency, and can be a low frequency in the same band as the Tx end user frequency. For instance, the F₁ Rx can be in the same band, but different frequency as F₁ Tx. The same transmit frequency is reused in multiple cells—that is, F₁ Tx is the same in each of the multiple F₁ cells, and the F₁ Rx is the same in each of the multiple F₁ cells; and F₄ Tx is the same in each of the multiple F₄ cells, and the F₄ Rx is the same in each of the multiple F₄ cells, etc. Note that the antenna gain-to-noise-temperature (G/T) and equivalent isotropic radiated power (EIRP) of the distributed antenna array 110 in space determines the number of bits per Hertz, frequency reuse and required power in each satellite 102.

The main frequencies are the transmit end user frequency Tx, the receive end user frequency Rx, the network (between the satellites 102 and the central satellite 104) frequency, the downlink gateway frequency and the uplink gateway frequency. The end user frequency Tx for example can be the LTE band 31. The Rx end user frequency can be the LTE band 156. As noted above, the WiFi network frequency can be 5 GHz. The downlink gateway frequency can be in the Ka band. And the uplink gateway frequency can also be in the Ka band.

Thus, the up- and down-links between the controller satellite 104 and the ground gateway 152 (located on Earth) are via high-frequency links, and the system can be designed to communicate to other satellite systems in space over different communication bands in order to reduce the number of gateways 152 required on Earth. Thus, the satellites 102 communicate directly with the end user device or terminals in low-frequencies and with the central satellite 200 via wireless communication network equivalent to WiFi. Here, the UE devices may communicate with the satellite system unmodified, using the same frequency bands and protocols that they use to communicate with a terrestrial cellular network. The system is capable of operating in low frequency, thereby connecting user devices and user terminal directly from and to the array 110 using low frequencies preferred for Moderate Obstacle Loss. Examples of frequency bands within the range of 100 MHz-2 GHz.

### Example System Architecture

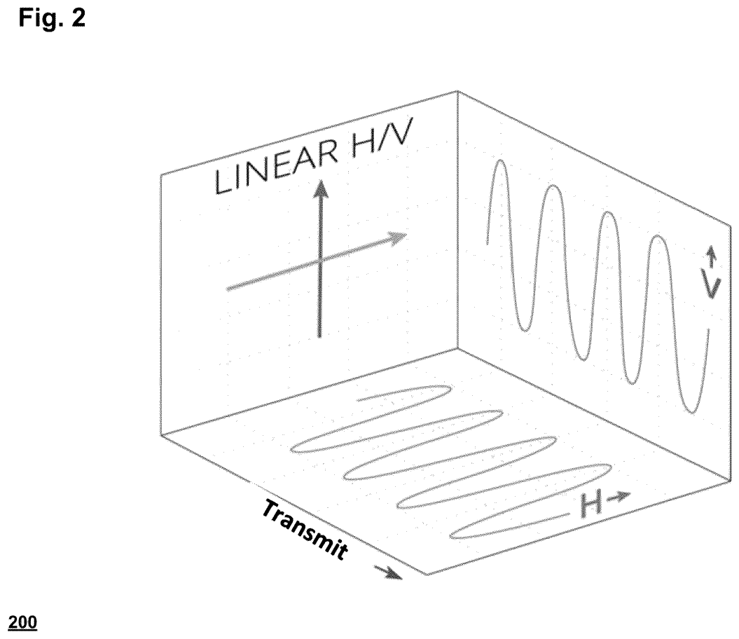

As noted above, client communication devices, such as UEs, may transmits signals having a specific polarization, such as horizontal or vertical polarization. FIG. 2 illustrates an example 200 showing these different polarizations.

In a direct to device environment, the UE (e.g., 150 in FIG. 1(b)) transmits a signal to a single satellite (e.g., 102 in FIG. 1(a)) or to a satellite array (e.g., 110 in FIG. 1(a)) in one polarization. If the satellite or array is working in the opposite polarization, the UE's transmitted signal would not be received. One solution is to split the satellite's or the array's antenna elements and receive simultaneously in both polarizations. However, this creates a disadvantage as the effective antenna size would be reduced, and would also reduce the efficiency of the antenna feeder link by 50%. Another solution would be to double the number of antenna elements in order to simultaneously handle both polarizations. This would create increases in cost, size and weight of the antenna configuration, each of which may be unfeasible for a satellite-based communication system.

In contrast, the present technology implements a switch arrangement that is designed to keep switching between the two opposing polarizations using the full antenna array at a selected dwell time that maintains the communication connection with the UE at a desired feeder link efficiency (e.g., at least a threshold feeder link efficiency). This makes the switching transparent to the user (e.g., the person using the UE).

According to an aspect of the technology, the switching process may identify the specific time at which the polarization would change on the satellite, so that the system can align the polarization change with operation by terrestrial equipment, such as the antenna of a given ground station. In one scenario, a delay equal or otherwise corresponding to the dwell time can be implemented. On the array side, all the elements should be aligned to switch at the same time.

As discussed further below, the UE would transmit a signal to the satellite in one polarization, either vertical (V) or horizontal (H) (or alternatively with 45° polarization). For the satellite to be able to receive the signal, it is important that the polarization matches: H with H or V with V. If the polarization is exactly the opposite (i.e., the UE transmits in H and the satellite receives in V, or vice versa), the signal would not be received and therefore the connection with the UE will drop. Even a partial mismatch can result in undesirable signal attenuation that can affect connection quality or the ability to maintain a connection. The fast switching between H and V of the present technology is designed so that when the UE signal is received, there will be a polarization match with the antenna's polarization.

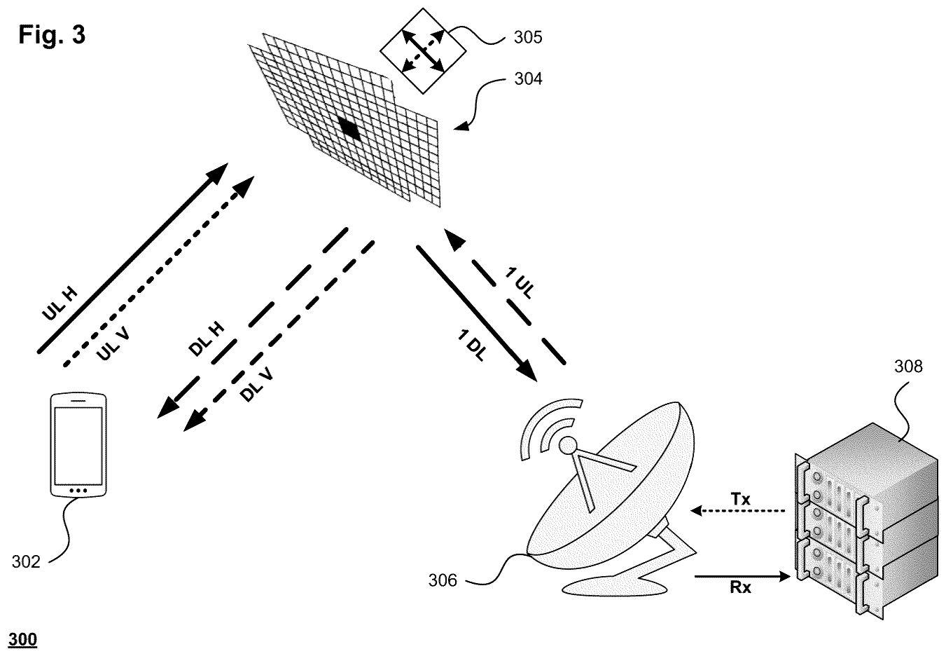

FIG. 3 illustrates an example scenario 300. Here, UE 302 is able to communicate directly with a satellite 304. The satellite 304 is shown as an array, which may be formed from a set of satellites 102 and/or 104 such as described above with regard to FIGS. 1(a) and 1(b). While some UEs may have multiple transmit antennas, others, such as UE 302 in this example, have a single transmit antenna. This transit antenna may transmit uplink signals to the satellite 304 with either vertical polarization (UL V) or horizontal polarization (UL H). Similarly, the downlink signal from the satellite 304 to the UE 302 may be sent with either vertical polarization (DL V) or horizontal polarization (DL H). A switching assembly or module 305 is illustrated with the satellite 304. The switching assembly or module 305 is configured switch between two different positions, one for horizontal polarization and another for vertical polarization, at a selected dwell time. For instance, as noted above the assembly or module may comprise a digital switch with a GPIO controller that is configured switch between horizontal and vertical polarizations, according to a selected dwell time. In one configuration, the switch may have a double pole-double throw (DPDT) arrangement, which enables simultaneous transmit and receive switching. In another configuration, a single pole-double throw (SDPT) arrangement may be employed, for instance for the uplink only, while transmitting in circular polarization from the downlink satellite to the ground.

Using the fast-switching technique, the satellite 304 is able to detect uplink signals in the UL V and UL H polarizations. Based on this, the satellite 304 is configured to communicate not only with the UE 302, but with antenna 306 of a ground station 308. Here, as shown there is only one downlink signal (1 DL) sent to the antenna 306, and only one uplink signal (1 UL) received from the antenna 306. Transmit (Tx) and receive (Rx) signals are passed between the ground station 308 and the antenna 306. The satellite 304 need not combine or split the polarized signals. Rather, it can be considered to be a dual polarization bent pipe between any UEs 302 and the antenna 306.

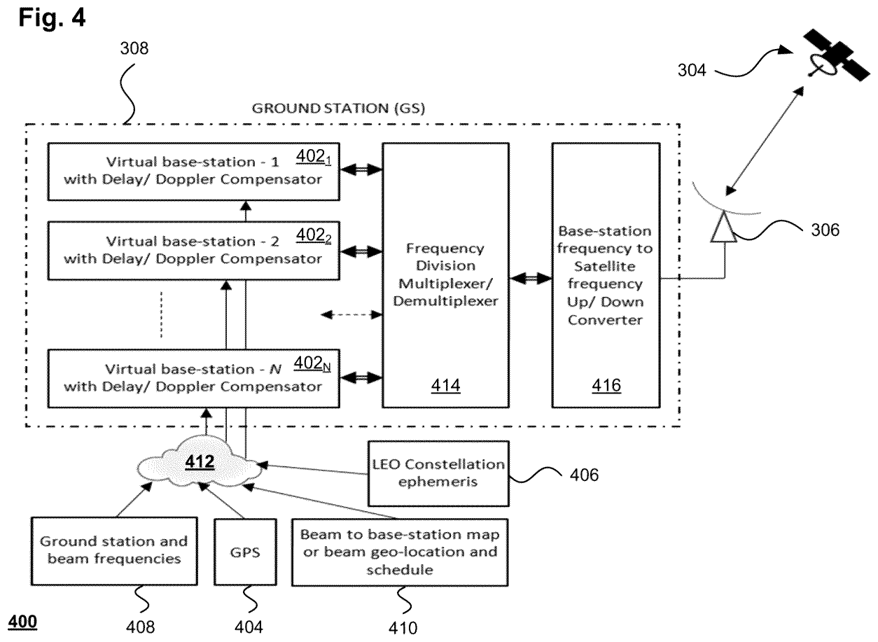

An example configuration 400 of the ground station 308 is shown in FIG. 4. This configuration illustrates the ground station equipment that is configured to generate the various beam signals and transmit to the satellite or array 304 (via the 1 UL arrow as shown in FIG. 3), and receive the various beam signals from the satellite or array 304 (via the 1 DL arrow as shown in FIG. 3). This configuration may support one or more virtual base stations or eNodeBs 402 to compensate for large delay and to support standard devices in 2G, 3G, 4G, and 5G or future standards. These devices may be implemented by one or more processors, such as a CPU, TPU, ASIC or other hardware-based processing element(s).

As shown, there may be “N” virtual base stations or eNodeBs 402, which in this example are configured to perform Doppler compensation and equalized delay compensation. Such Doppler and delay compensation may be performed in accordance with aperture of the satellite array 304 relative to the beam center. The larger the aperture, the smaller the (worst-case) residual Doppler (after residual Doppler compensation) would be in the beam. By way of example, LTE does not tolerate residual Doppler >1200 Hz nor delay fast variations >0.5 ms that cannot be corrected with timing advance (TA) commands. So, a) there has to be delay/Doppler compensation/equalization and b) the residual delay/doppler variations must be small. The method of compensation at the ground station 308 can be the same as the compensation done at the satellite. So in an alternative configuration, such compensation may be done at the satellite instead of the virtual base stations 402.

The virtual base-stations 402₁, 402₂, . . . , 402_{N} are configured to generate/receive the signals to/from the UE in N beams of the satellite footprint through the satellite/array 304, eNodeBs and other virtual base station devices 402 may support dual transmit and dual receive, meaning that one transmit port and one receive port for each polarization are available. Each base-station transmitted/received signal in this configuration can go through a delay/Doppler compensation aided by inputs from GPS module 404, LEO constellation ephemeris module 406, ground station and beam frequency module 408, and beam to base-station map or beam geo-location and schedule module 410. The GPS module 404 provides the location co-ordinates of the ground station 308, and the LEO constellation ephemeris module 406 provides the co-ordinates of the satellite or array 304. The ground station and beam frequencies module 408 provides a list of the ground station uplink/downlink frequency assigned to each base-station to/from the satellite/array 304, and corresponding uplink/downlink frequency assigned to each beam in the satellite footprint to/from the satellite/array 304. The beam to base-station map and schedule module 410 lists which beam is assigned to which base-station and the time instances when a base-station starts generating/receiving a signal to/from the beam and when it is stopped.

The inputs from modules 404, 406, 408, and 410 can aid in computing the delay/Doppler trend by the processing device(s) well ahead of the satellite passes over the beam. For Doppler compensation, when the satellite pass starts over the beam, the inverse Doppler is applied to the virtual base-station generated signal that cancels Doppler effect due to LEO formation movement in the forward direction (from ground station to satellite/array to UE), resulting in near zero Doppler as seen by the UE. Similarly, the inverse Doppler is applied on the downlink from satellite/array prior to feeding to virtual base-station to cancel the Doppler effect in the reverse direction (from UE to satellite/array to ground station).

Likewise, any virtual base-stations communicating with other beams and virtual base-stations at other ground stations can also maintain a near constant path delay and near zero Doppler for the respective satellite formations in a satellite constellation. Since the overall path delay/Doppler is maintained to be near similar across beams and across LEO formations, the UEs quickly synchronize to new beams whenever there is transition of a UE between beams or transition of a beam from a setting LEO formation footprint to a rising LEO formation footprint, thereby providing a smooth transition from satellite to satellite of a given UE.

All of the inputs 404, 406, 408 and 410 may be obtained over a local area network (LAN) or over a cloud from a remote network 412. The signals of each virtual base-station 402 could be a common LTE band frequency (f), they are interleaved/de-interleaved in frequency to/from (f₁, f₂, . . . , f_{N}) using frequency division multiplexer/de-multiplexer 414. The composite signal of all base-stations from/to the multiplexer/de-multiplexer 414 is then frequency shifted to/from a satellite frequency band (e.g., Q or V-band) by the base-station frequency to satellite frequency up/down converter 416, which is sent to the ground station antenna 306 (e.g., via the Tx signal as shown in FIG. 3). The ground station antenna 306 transmits/receives the composite base-station signals to/from the satellite or array 304 (e.g., via the 1 UL/1 DL signals as shown in FIG. 3).

### Example Switching Arrangements

The following provides exemplary dual-polarization configurations for antenna arrays as described herein.

While custom antenna polarization arrangements can be employed, in one scenario the following approach can be utilized with an existing antenna array in a way that does not lower the transmit power into the antenna port, and the noise figure of the receiver is not degraded as compared to a single polarization design. It may be desirable to maintain an existing number analog-to-digital converters (ADCs) and digital-to-analog converters (DACs). Each element is able to support two orthogonal linear polarization states (e.g., horizontal and vertical).

According to aspects of the technology, the phased array antenna should be capable of transmitting 2 and receiving 2 collocated beams for each cell, in opposite orthogonal polarizations. Each of the 2 received beams may be transmitted down to the gateway through a Q/V link, but on different frequencies. Each of the 2 beams to be transmitted would then be received from the gateway through the corresponding Q/V link in different frequencies. The two polarizations for each transmit and receive element remain orthogonal to each other in the direction of each UE on the ground (or at sea or in the air) within a given cell. However, this does not necessarily need to be kept constant across the beam.

According to another aspect of the technology, the beam radiation pattern diagram for the dual polarization design should remain the same as or otherwise equivalent to a single polarization design. For instance, the beam radiation patterns should not create interference or impact service performance of the communication system.

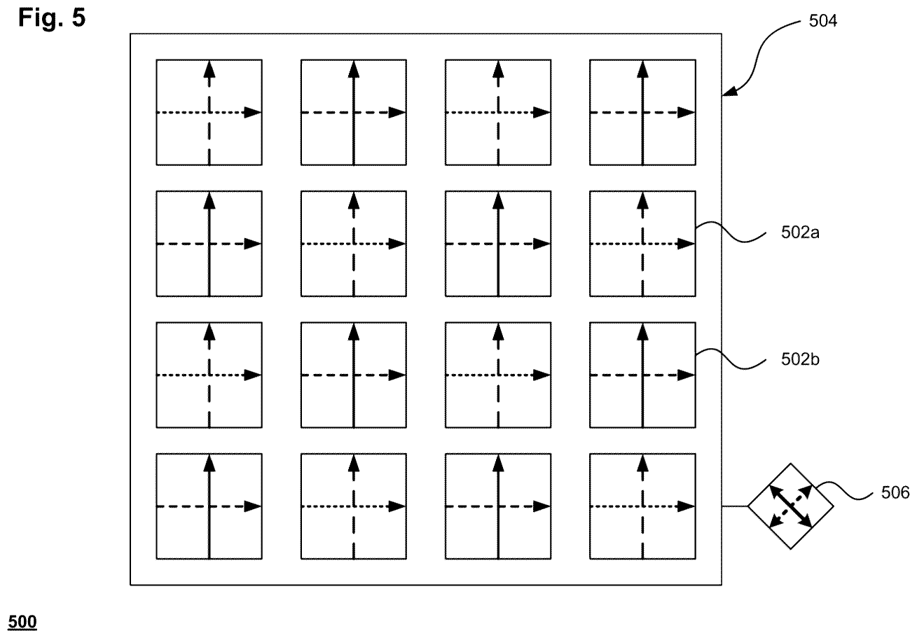

FIG. 5 illustrates an example 500 of polarization beamforming for different antenna elements 502 in an array 504, in which the array 504 will be split between two polarizations. As shown, certain elements 502a have a vertically polarized Tx (downlink) as shown by the long-dashed arrows, and a horizontally polarized Rx (uplink) as shown by the dotted arrows. In this example, other elements 502b have a vertically polarized Rx (uplink) as shown by the solid arrows, and a horizontally polarized Rx (downlink) as shown by the short-dashed arrows. In another example, the horizontal and vertical polarizations in each element 502 may be flipped. In further examples, there may be different combinations of polarizations, with a downlink polarization in either the horizontal or vertical polarization in a given element is combined with an uplink polarization in the opposite vertical or horizontal polarization. Switching assembly or module 506 is configured to cause the antenna elements 502 to switch their polarization according to a selected dwell time.

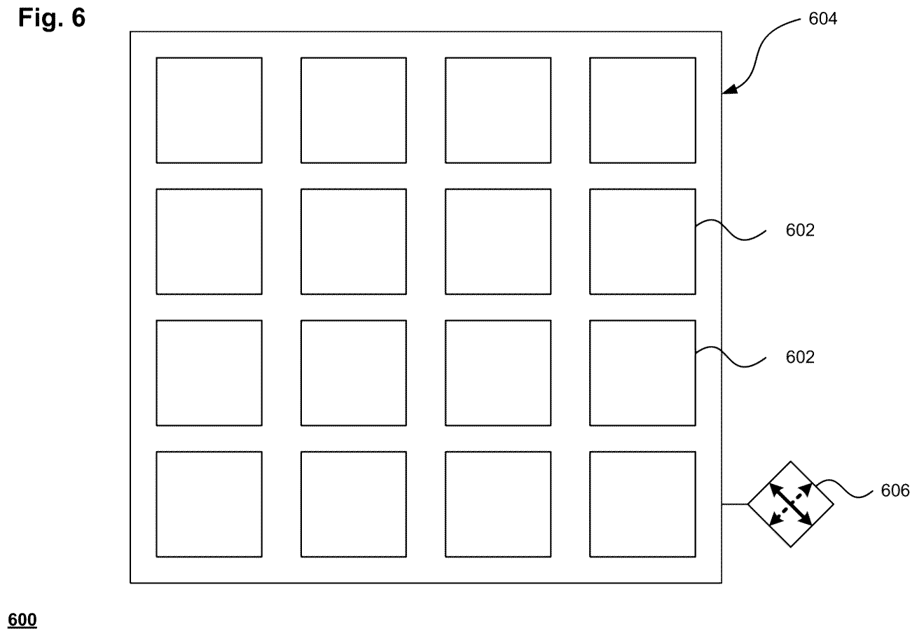

FIG. 6 illustrates another example 600, which is a more general case. In particular, at any given time all antenna elements 602 in a phase array 606 will be in one polarization or the other. The instantaneous polarization of all elements 602 is controlled by switching assembly or module 606. Thus, all of the elements 602 of the phase array 606 will switch at the specific dwell time to the same polarization. Note that the approach as shown in FIG. 5 can result in increased spacing between co-polarized array elements over a configuration in which all elements are polarized in the same way such as shown in FIG. 6. By way of example, such interleaving solution may increase the spacing by 40% or more, which can be beneficial in certain applications.

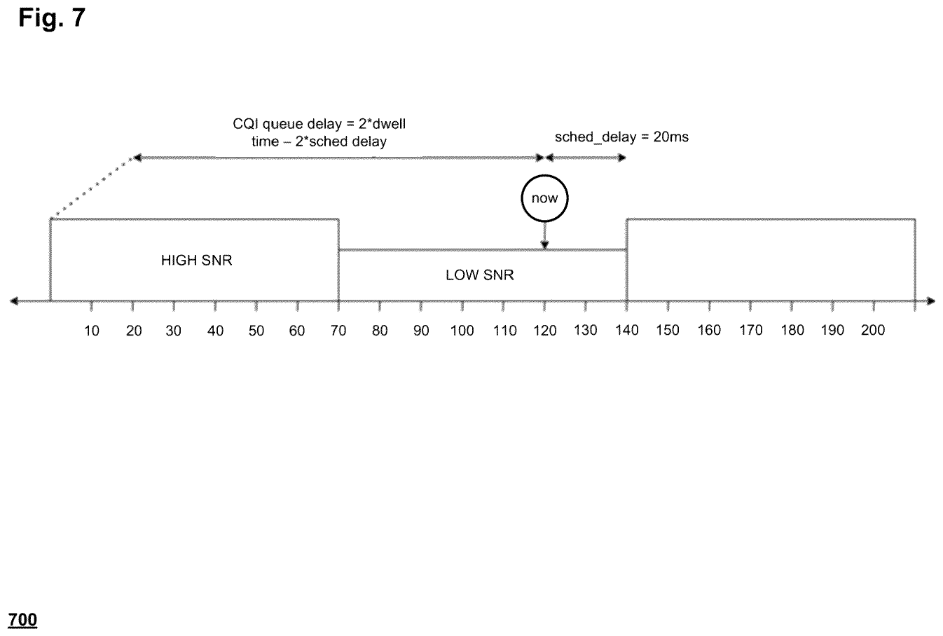

In one approach, channel quality indicator (CQI) enqueuing can be applied with the present technology. CQI is a metric that measures the quality of the signal being received to determine if the selected modulation and coding system (MCS) is the most efficient. The system may always try to utilize the highest MCS to get more throughput; however, this can be at the expense of link margin. Thus, using the switching methodology discussed herein, if one were to use the standard time to decide whether the MCS needs to be increased or not, that could potentially fail as the polarization can change right after the decision is taken. Therefore, the approach, which is shown in FIG. 7 as scenario 700, is to make the decision at the standard time+2× times the switching dwell time −2× times scheduling delay. This proves to be more efficient than just using the standard time.

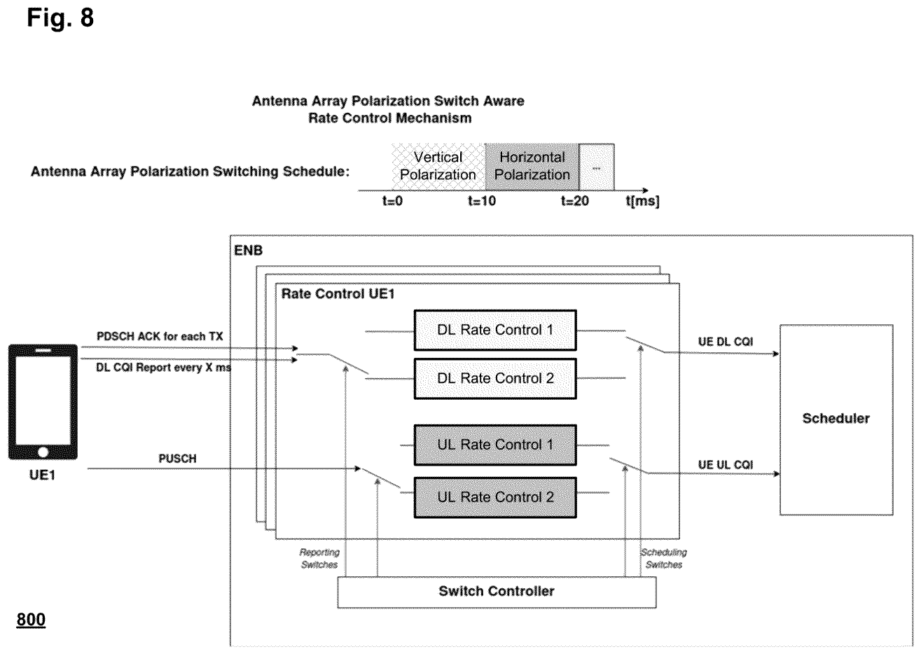

Another approach is shown as scenario 800 of FIG. 8, which entails two rate control objects for each UE. According to this approach, if the precise time the switching happens is known, (so the system knows exactly when it is in H or when it is in V), the eNB can know exactly which CQI reports were measured during H and V polarizations, and can use the correct CQI reports to schedule transmissions with optimal MCS during the current polarization (either H or V).

In both approaches the UEs are grouped based on performance during H and V array polarization, then, the eNB can schedule them only during dwell time when they can get the best performance (and only absolutely required control traffic during the low-performance period to keep the link alive).

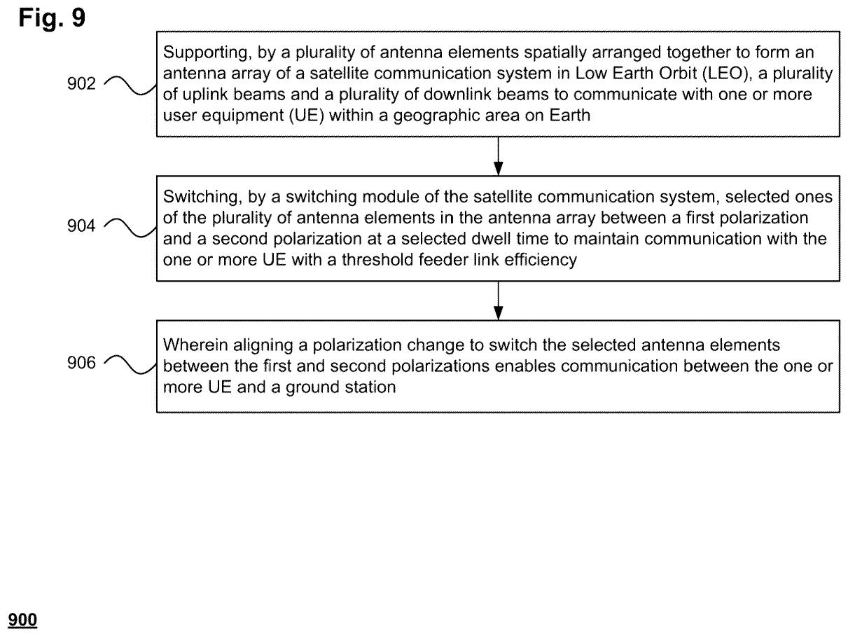

FIG. 9 illustrates an example method 900 in accordance with aspects of the technology.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

Moreover, unless expressly stated otherwise, the foregoing examples and arrangements are not mutually exclusive and may be implemented in various ways to achieve unique advantages. These and other variations and combinations of the features discussed herein can be employed without departing from the subject matter defined by the claims. In view of this, the foregoing description of exemplary embodiments should be taken by way of illustration rather than by way of limitation.

Reference to one or more processors, processing devices or processing elements herein includes situations where a set of processors may be configured to perform one or more operations, such as implementation of a virtual base station with delay/doppler compensation, or the modules discussed herein. Any combination of such a set of processors may perform individual operations or a group of operations. This may include two or more CPUs or TPUs (or other hardware-based processors) or any combination thereof. It may also include situations where the processors have multiple processing cores. Therefore, reference to “one or more processors” does not require that all processors (or cores) in the set must each perform all of the operations. Rather, unless expressly stated, any one of the one or more processors (or cores) may perform different operations when a set of operations is indicated, and different processors (or cores) may perform specific operations, either sequentially or in parallel.

The examples described herein, as well as clauses phrased as “such as,” “including” and the like, should not be interpreted as limiting the subject matter of the claims to any specific examples. Rather, such examples are intended to illustrate possible embodiments. Further, the same reference numbers in different drawings can identify the same or similar elements. The processes or other operations may be performed in a different order or concurrently, unless expressly indicated otherwise herein.

Modifications, additions, or omissions may be made to the systems, apparatuses, and methods described herein without departing from the intended scope of the disclosure. For example, the components of the systems and apparatuses may be integrated or separated. Moreover, the operations of the systems and apparatuses disclosed herein may be performed by more, fewer, or other components and the methods described may include more, fewer, or other steps. As used in this document, “each” refers to each member of a set or each member of a subset of a set.

1. A satellite communication system, comprising:
a plurality of antenna elements spatially arranged together to form an antenna array for operation in Low Earth Orbit (LEO), the plurality of antenna elements configured to support a plurality of uplink beams and a plurality of downlink beams to communicate with one or more user equipment (UE) within a geographic area on Earth; and
a switching module operatively coupled to each of the plurality of antenna elements in the antenna array, the switching module configured to switch selected ones of the plurality of antenna elements in the antenna array between a first polarization and a second polarization at a selected dwell time that maintains communication with the one or more UE with a threshold feeder link efficiency;
wherein the system is configured to align a polarization change to switch the selected antenna elements between the first and second polarizations to enable communication between the one or more UE and a ground station.

2. The satellite communication system of claim 1, wherein the switching module comprises a double pole-double throw configuration to simultaneously support communication via the plurality of uplink beams and the plurality of downlink beams.

3. The satellite communication system of claim 1, wherein a communication link supported by the system between the one or more UE and the ground station has a dual polarization bent pipe configuration.

4. The satellite communication system of claim 1, wherein the antenna array is configured to transmit at least two and receive at least two collocated beams for each cell within a field of view of the antenna array.

5. The satellite communication system of claim 1, wherein the switching module is configured to switch all of the plurality of antenna elements at the selected dwell time to either the first polarization or the second polarization.

6. The satellite communication system of claim 1, wherein one of the first polarization and the second polarization is horizontal polarization, and the other one of the first polarization and the second polarization is vertical polarization.

7. The satellite communication system of claim 1, wherein the switching module provides a single pole-double throw configuration for uplink communication via the uplink beams.

8. The satellite communication system of claim 1, wherein the system does not combine any polarized signals.

9. The satellite communication system of claim 1, wherein the system does not split any polarized signals.

10. The satellite communication system of claim 1, wherein the ground station is a virtual base station or an eNodeB.

11. The satellite communication system of claim 1, wherein the system is configured to:
identify a specific time at which polarization would change; and
align the polarization change with operation by the one or more UE or the ground station.

12. The satellite communication system of claim 1, wherein the system is further configured to implement a delay corresponding to the selected dwell time.

13. A method, comprising:
supporting, by a plurality of antenna elements spatially arranged together to form an antenna array of a satellite communication system in Low Earth Orbit (LEO), a plurality of uplink beams and a plurality of downlink beams to communicate with one or more user equipment (UE) within a geographic area on Earth; and
switching, by a switching module of the satellite communication system, selected ones of the plurality of antenna elements in the antenna array between a first polarization and a second polarization at a selected dwell time to maintain communication with the one or more UE with a threshold feeder link efficiency;
wherein aligning a polarization change to switch the selected antenna elements between the first and second polarizations enables communication between the one or more UE and a ground station.

14. The method of claim 13, wherein a communication link between the one or more UE and the ground station has a dual polarization bent pipe configuration.

15. The method of claim 13, further comprising the antenna array transmitting two and receiving two collocated beams for each cell within a field of view of the antenna array.

16. The method of claim 13, wherein the switching includes switching all of the plurality of antenna elements at the selected dwell time to either the first polarization or the second polarization.

17. The method of claim 13, further comprising:
identifying a specific time at which polarization would change; and
aligning the polarization change with operation by the one or more UE or the ground station.

18. The method of claim 17, further comprising implementing a delay corresponding to the selected dwell time.

19. The method of claim 13, wherein one of the first polarization and the second polarization is horizontal polarization, and the other one of the first polarization and the second polarization is vertical polarization.

20. The method of claim 13, wherein:
the first polarization is a first selected linear polarization that is non-horizontal and non-vertical; and
the second polarization is a second selected linear polarization that is orthogonal to the first selected linear polarization.
